(19) United States
(12) Patent Application Publication
(10) Pub. No.: US 2019/0303854 A1
(43) Pub. Date: Oct. 3, 2019

(54) DELIVERY VERIFICATION SYSTEM USING VIDEOS AND BLOCKCHAIN

(71) Applicant: Walmart Apollo, LLC, Bentonville, AR (US)

(72) Inventors: John Jeremiah O'Brien, Farmington, AR (US); Daniel Wayne Young, Rogers, AR (US); Robert Cantrell, Herndon, VA (US); Brian Gerard McHale, Oldham (GB); Bruce W. Wilkinson, Rogers, AR (US); Donald Ray High, Noel, MO (US)

(21) Appl. No.: 16/367,823

(22) Filed: Mar. 28, 2019

Related U.S. Application Data
(60) Provisional application No. 62/650,405, filed on Mar. 30, 2018.

(51) Int. Cl. G06Q 10/08; H04N 21/433; G06F 16/182

(52) U.S. Cl. CPC G06Q 10/0833; G06F 16/1824; H04N 21/4334

(57) ABSTRACT

Systems, methods, and machine readable media are provided for delivery verification. Delivery of a package is initiated by a courier by submitting an action to a distributed ledger. The courier records video of the delivery of the package to a customer site. The video of the delivery of the package is sent to a blockchain referenced by the distributed ledger. The video of the delivery of the package is added to the blockchain. The customer captures any motion detected video of the package occurring after delivery of the package by the courier and this video is added to the blockchain.

### RELATED APPLICATIONS

This application claim priority to, and the benefit of, U.S. Provisional Application No. 62/650,405, filed on Mar. 30, 2018, which is incorporated by reference herein in its entirety.

### BACKGROUND

Distributed ledgers present a new paradigm for how information is collected and communicated. A distributed ledger is a database that is spread across several nodes or computing devices. Each node replicates and saves an identical copy of the ledger. Each participant node of the network updates itself independently.

A blockchain is a technology that allows for fast, secure and transparent peer-to-peer transactions. Once the transactions within a block are deemed valid it is attached to the most recently verified block in the chain, creating a sequential ledger which is viewable by others. This process continues in perpetuity, expanding upon the blockchain's contents and providing a public record that can be trusted. In addition to being constantly updated, the chain and all of its blocks are distributed across the network to a large number of machines.

### BRIEF DESCRIPTION OF THE DRAWINGS

The accompanying drawings, which are incorporated in and constitute a part of this specification, illustrate one or more embodiments and, together with the description, help to explain the invention. The drawings are not necessarily to scale, or inclusive of all elements of a system, emphasis instead generally being placed upon illustrating the concepts, structures, and techniques sought to be protected herein. In the drawings:

FIG. 1 is a block diagram showing a delivery verification system, according to an example embodiment.

FIG. 2 is a flow diagram showing a courier process using a delivery verification system, according to an example embodiment.

FIG. 3 is a flow diagram showing a first customer process using a delivery verification system, according to an example embodiment.

FIG. 4 is a flow diagram showing a second customer process using a delivery verification system, according to an example embodiment.

FIG. 5 is a block diagram of an exemplary computing device that may be used to implement exemplary embodiments described herein.

### DETAILED DESCRIPTION

Exemplary embodiments provide a delivery verification system using videos and blockchain. A courier records delivery of a package to a customer site and the video record of the delivery is added to a block chain which is used to verify delivery, as well as to verify the condition of the package when it was delivered. A customer video shows any activity taking place regarding the package delivery and before the package is received by the customer. This could include the theft of the package by a nefarious third party or damage done to the package by a person, an animal, weather, or an act of nature. The customer video is also added to the block chain, thereby providing a complete video record from initialization of the package delivery process to receipt by the customer.

In one embodiment, a delivery verification system using videos and blockchain comprises one or more computer-readable media storing instructions for delivery verification, the one or more devices are operatively coupled to the computer-readable media. The one or more devices can be configured to initiate, by a courier, delivery of a package by submitting an action to a distributed ledger. The computer readable media further includes instructions to record, by a courier video capture system, video of the delivery of the package to the customer site; and delivery of the package by the courier to the customer site is completed by sending a code to the distributed ledger. In certain embodiments, the computer readable media includes instructions wherein the one or more devices are further configured to send video of the delivery of the package captured by the courier video capture system to a blockchain referenced by the distributed ledger; and to compile, by the distributed ledger. The video of the delivery of the package by the courier video capture system is added to the blockchain. The computer readable media may further include instructions for capturing, by a customer video capture system, any motion detected video of the package occurring before and/or after delivery of the package by the courier and also to request, by the distributed ledger, any motion detected video of the package captured by the customer video capture system. The customer receives the package and sends a message to the distributed ledger that the package has been received; and add the motion detected video of the package captured by the customer video capture system is added to the blockchain.

In another embodiment, a computer-implemented method for delivery verification includes initiating, by a courier, delivery of a package by submitting an action to a distributed ledger; and recording, by a courier video capture system, video of the delivery of the package by the courier to a customer site. The method also includes completing delivery of the package by the courier to the customer site by sending a code to a distributed ledger; and sending the video of the delivery of the package captured by the courier video capture system to a blockchain referenced by the distributed ledger. The method further includes compiling, by the distributed ledger, the video of the delivery of the package captured by the courier video capture system and adding the video of the delivery of the package captured by the courier video capture system to the blockchain. The method additionally includes capturing, by a customer video capture system, any motion detected video of the package occurring after delivery of the package by the courier; requesting, by the distributed ledger, the motion-detected video of the package captured by the customer video capture system; receiving, by the customer, the package and sending a message to the distributed ledger that the package has been received. The method further includes adding the motion detected video footage captured after delivery of the package by the customer video capture system to the blockchain.

In another embodiment, a non-transitory machine-readable medium is provided that stores instructions executable by processing devices. Execution of the instructions causes the processing devices to initiate delivery of a package by submitting an action to a distributed ledger; and recording, by a courier video capture system, video of the delivery of the package by the courier to a customer site. The method also includes completing delivery of the package by the courier to the customer site by sending a code to a distributed ledger; sending the video of the delivery of the package captured by the courier video capture system to a blockchain referenced by the distributed ledger; compiling, by the distributed ledger, the video of the delivery of the package captured by the courier video capture system; and adding the video of the delivery of the package captured by the courier video capture system to the blockchain. The method additionally includes capturing, by a customer video capture system, any motion detected video of the package occurring after delivery of the package by the courier; requesting, by the distributed ledger, the motion-detected video of the package captured by the customer video capture system; receiving, by the customer, the package; sending a message to the distributed ledger that the package has been received; and adding the motion detected video footage captured after delivery of the package by the customer video capture system to the blockchain.

There are several problems associated with package delivery. One problem is theft of the package. There are occasions wherein a package is successfully delivered and left on the customer's front step or porch, and a third party steals the package. The customer has no idea if the package was delivered, or if the package was delivered and then stolen. In some instances, the package is delivered to the wrong location. In some instances the package may be damaged. The damage can happen in a number of ways—the package may have been dropped or damaged during delivery, the package may be damaged after delivery to the customer site, for example by a person or animal. The package may be delivered in good condition but weather may have damaged the package (rain, snow, wind), or an accident such as a falling tree branch may have damaged the package.

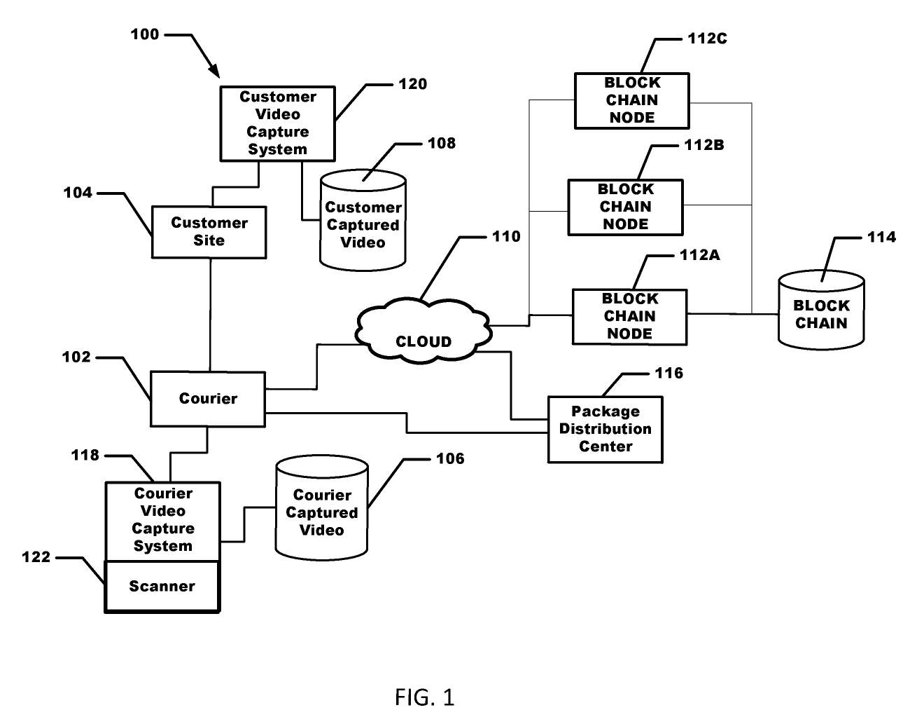

It is important to be able to verify that the package was delivered, that the package was delivered in good condition, and that the package was not stolen or damaged after delivery. This verification of the package delivery and condition at delivery, in one embodiment, is accomplished by the courier. Referring to FIG. 1, a system 100 for providing delivery verification is shown. System 100 includes a package distribution center 116 where the package is picked up by courier 102. The package distribution center is a retail store or a delivery center (e.g. Federal Express®). Courier 102 records courier captured video 106 of the delivery using a courier video capture system 118. Similarly, customer site 104 records customer captured video 108 using a customer video capture system 120. In some embodiment, the video capture system used by the customer includes a motion-activated recording device. The customer and the courier are in communication with a cloud/network 110 which is also in communication with one or more blockchain nodes 112A, 112B and 112C that maintains a blockchain 114.

In an example embodiment, one or more portions of network 110 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks. As used herein the term “video” includes images recorded over a period of time, one or more still pictures, and time lapse photography.

In one embodiment, the courier initiates the delivery process by submitting an action to a distributed ledger of the blockchain 114 via the blockchain nodes 112A-112C. The distributed ledger sends a blockchain reference to the courier to use for video distribution. This courier picks up the package at the package distribution center and records the delivery using the courier video capture system, which can include: a digital video camera, a smart phone, a body camera, helmet camera, or glasses camera, to record the delivery wherein the video shows the package, the condition of the package, and the location to which the package is delivered. The video can also capture a machine-readable element disposed on the package. The machine readable element can be encoded with an identifier that can be used by the system to identify the contents of the package. The courier video capture system can attach metadata to the recorded video including, for example, a time-stamp indicating the date and time the video was captured and geolocation information indicating a geographic location at which the video was captured (e.g., latitude and longitude or a street address). Upon completion of the delivery of the package to the customer site, the courier video capture system sends a code to a blockchain node for the distributed ledger. The distributed ledger via the blockchain node requests delivery of the video taken by the courier's video capture system. The courier video capture system sends the video of the delivery to the ledger's referenced blockchain e.g., via the network 110 and the blockchain node. The distributed ledger via the one or more blockchain nodes 112A-112C compiles the courier video and adds the video (and the attached metadata) to the blockchain.

As discussed herein, in one embodiment, the video taken by the courier video capture system includes geographic metadata. The geographic metadata is distributed to the ledger system. The geographic metadata is captured at the time of delivery. The customer site may be a property, a vehicle, a kiosk, a delivery site, a locker or the like. The vehicle may be static or dynamic.

In some embodiments, the courier scans a Quick Response (QR) code or communicates with a near field communications (NFC) device of the customer using a scanning/reader device 122. The scanning/reader device can be integrated with or in communication with the courier's video capture system. The courier arrives at the customer site, scans the QR code via the scanning/reader device, and takes a picture or video of the package at customer site using the courier video capture system. The metadata from the QR code is included with the picture or video. In some embodiments, the delivery may be made inside the home of the customer, for example to stock perishable items in a refrigerator, which is recorded by the customer's video capture system e.g., with an inside home camera. In other embodiments, the package is delivered to locker, a kiosk, or a delivery box. The customer site in some embodiments is a vehicle with a dashboard camera. Deliveries to the vehicle are captured by the dashboard camera or another recording device associated with the vehicle. In one embodiment, once the package has been delivered and the delivery recorded, the courier video capture systems includes an element to flag if the package stays in the GPS proximity of the carrier, in order to ensure the carrier actually leaves the package after recording the delivery.

It is also important to track the package once it has been delivered to the customer site, but has not yet been received by the customer yet. The customer may be at work or otherwise away from home when the package is delivered. In one embodiment, the courier can use the customer's Wireless Fidelity (WiFi) network to trigger the customer video capture system. In one embodiment, the customer's video capture system captures video, for example, from a motion-activated recording device before, during, and/or after the package has been delivered. The motion-activated recording device of the customer's video capture system can be triggered when it detects motion such as when the courier is approaching the premises, placing the package on the premises, and/or leaving the premises. Using this approach, the customer's recording system can create a record of whether anything happened to the package before, during, and/or after delivery. The video recorded by the customer's recording system can attach metadata to the recorded video including, for example, a time-stamp indicating the date and time the video was captured and geolocation information indicating a geographic location at which the video was captured (e.g., latitude and longitude or a street address). The customer video capture system receives the block chain reference and the distributed ledger via one of the blockchain nodes requests transfer of the video recorded by the customer's video capture system. The customer video capture system sends the recorded video to the ledger's referenced block chain, where the motion-activated video is added to the blockchain. The transaction is now complete. The blockchain can be viewed by the courier, the customer and the package distribution center. The time-stamp and geolocation metadata from the customer's video and the time-stamp and geolocation metadata from the courier's image capture device can be compared to verify deliver and any incidents that happen before, during, or after the delivery.

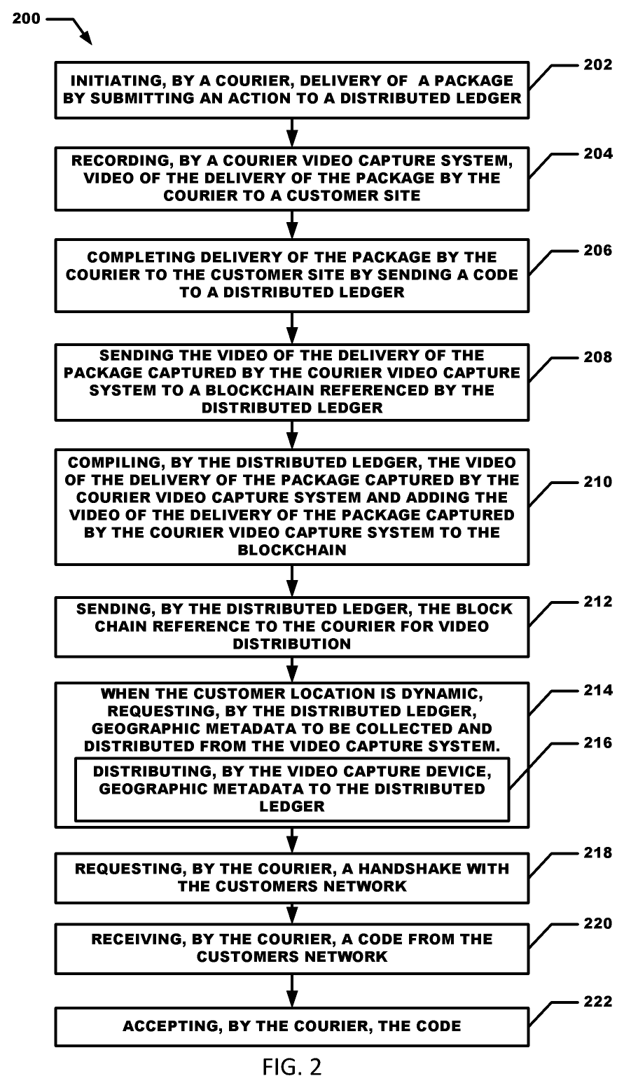

FIGS. 2-4 are flow diagrams showing illustrative processing that can be implemented within a system for delivery verification in an exemplary embodiment. Rectangular elements are herein denoted “processing blocks” and represent computer software instructions or groups of instructions. Alternatively, the processing blocks may represent steps performed by functionally equivalent circuits such as a digital signal processor (DSP) circuit or an application specific integrated circuit (ASIC). The flow diagrams do not depict the syntax of any particular programming language but rather illustrate the functional information one of ordinary skill in the art requires to fabricate circuits or to generate computer software to perform the processing required of the particular apparatus. It should be noted that many routine program elements, such as initialization of loops and variables and the use of temporary variables may be omitted for clarity. The particular sequence of blocks described is illustrative only and can be varied without departing from the spirit of the concepts, structures, and techniques sought to be protected herein. Thus, unless otherwise stated, the blocks described below are unordered meaning that, when possible, the functions represented by the blocks can be performed in any convenient or desirable order.

Referring now to FIG. 2, a flow diagram showing a courier process 200 using a delivery verification system is presented. Processing begins with processing block 202 which discloses initiating, by a courier, delivery of a package by submitting an action to a distributed ledger. The courier picks up the package from a package distribution center.

Processing block 204 shows recording, by a courier video capture system, video of the delivery of the package by the courier to a customer site. The courier may do so using a smart device such as an Iphone®, using a body camera, or using any other type of recording device.

Processing block 206 recites completing delivery of the package by the courier to the customer site by sending a code to a distributed ledger. The distributed ledger has confirmation that the delivery of the package to the customer site has been performed. Processing block 208 discloses sending the video of the delivery of the package captured by the courier video capture system to a blockchain referenced by the distributed ledger.

Processing block 210 discloses compiling, by the distributed ledger, the video of the delivery of the package captured by the courier video capture system and adding the video of the delivery of the package captured by the courier video capture system to the blockchain. The video of the delivery is available to the courier, the customer and someone at the package delivery center.

Processing block 212 shows sending, by the distributed ledger, the block chain reference to the courier for video distribution. Processing block 214 recites when the customer location is dynamic, requesting, by the distributed ledger, geographic metadata to be collected and distributed from the video capture system. As shown in processing block 216 the process further includes distributing, by the video capture device, the geographic metadata to the distributed ledger.

Processing block 218 recites requesting, by the courier, a handshake with the customer's network. Processing block 220 discloses receiving, by the courier, a code from the customer's network. Processing block 222 shows accepting, by the courier, the code. The code can be used to begin the customer process of verifying delivery.

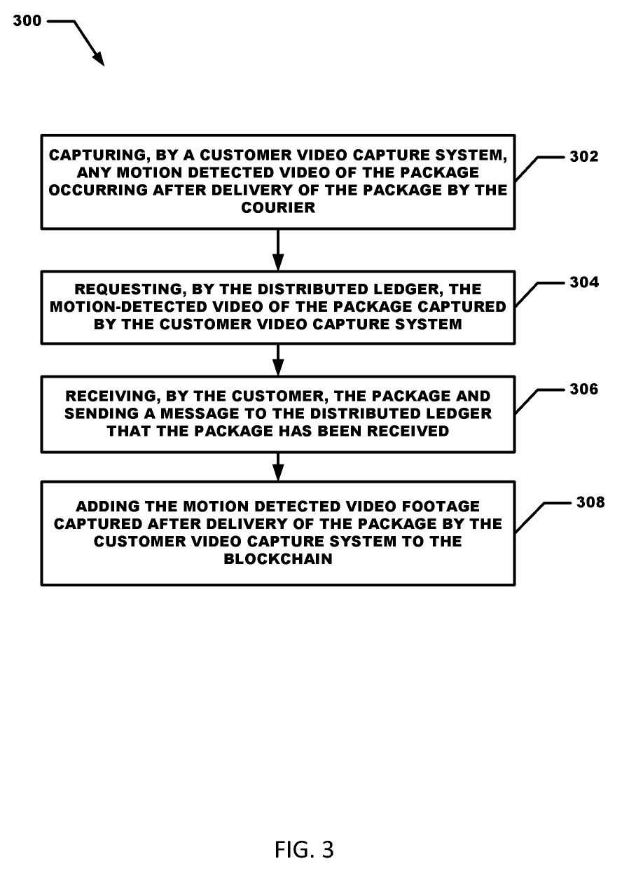

Referring to FIG. 3, a first customer process 300 for verifying a delivery of a package is shown. This process 300 is used in conjunction with the courier process described with respect to FIG. 2. Process 300 begins with processing block 302 which discloses capturing, by a customer video capture system, any motion detected video of the package occurring after delivery of the package by the courier. This video also shows the package was delivered and the condition of the package as it was delivered. Any further action recorded would show any non-customer actions regarding the package, such as stealing of the package by a third party, damaging of the package by a third party or animal, or damage of the package due to weather or natural causes.

Processing block 304 shows receiving, by the customer, the package and sending a message to the distributed ledger that the package has been received. In one embodiment, the customer has returned home and received the delivered package.

Processing block 306 recites requesting, by the distributed ledger, the motion-detected video of the package captured by the customer video capture system. Processing block 308 discloses adding the motion detected video footage captured after delivery of the package by the customer video capture system to the blockchain. This block chain can be used to view the delivery of the package by the courier, and further any actions that happened to the package between delivery by the courier and receipt of the package by the customer.

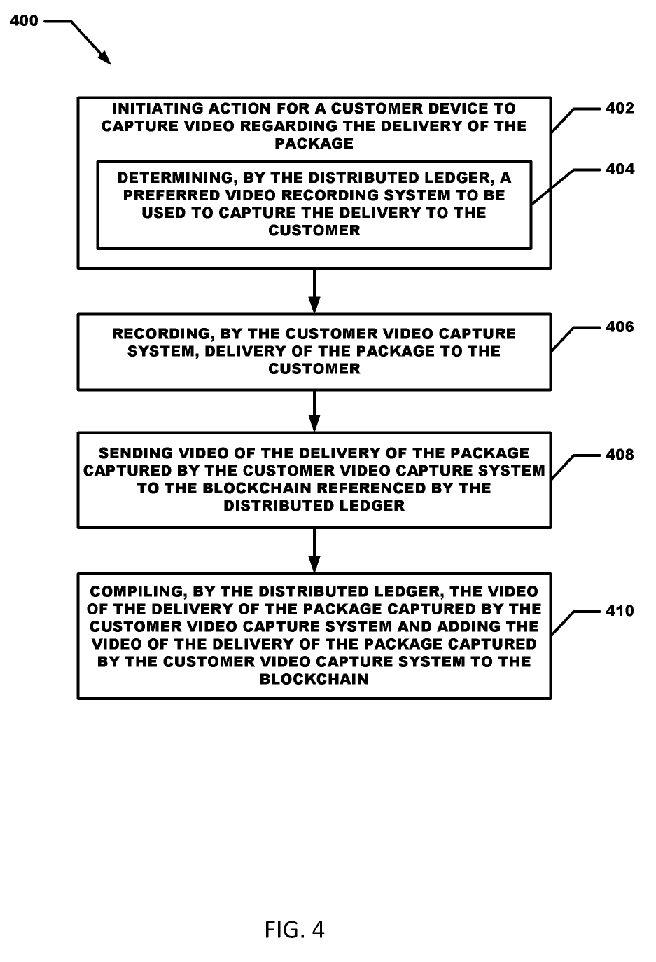

Referring to FIG. 4, a second customer process for verifying delivery of a package is shown. This process is used in conjunction with the processes described in FIG. 2 and FIG. 3. Process 400 begins with processing block 402 which discloses initiating action for a customer device to capture video regarding the delivery of the package. Processing block 404 shows determining, by the distributed ledger, a preferred video recording system to be used to capture the delivery to the customer.

Processing block 406 recites recording, by the customer video capture system, delivery of the package to the customer. Processing block 408 discloses sending video of the delivery of the package captured by the customer video capture system to the blockchain referenced by the distributed ledger. Processing block 410 shows compiling, by the distributed ledger, the video of the delivery of the package captured by the customer video capture system and adding the video of the delivery of the package captured by the customer video capture system to the blockchain.

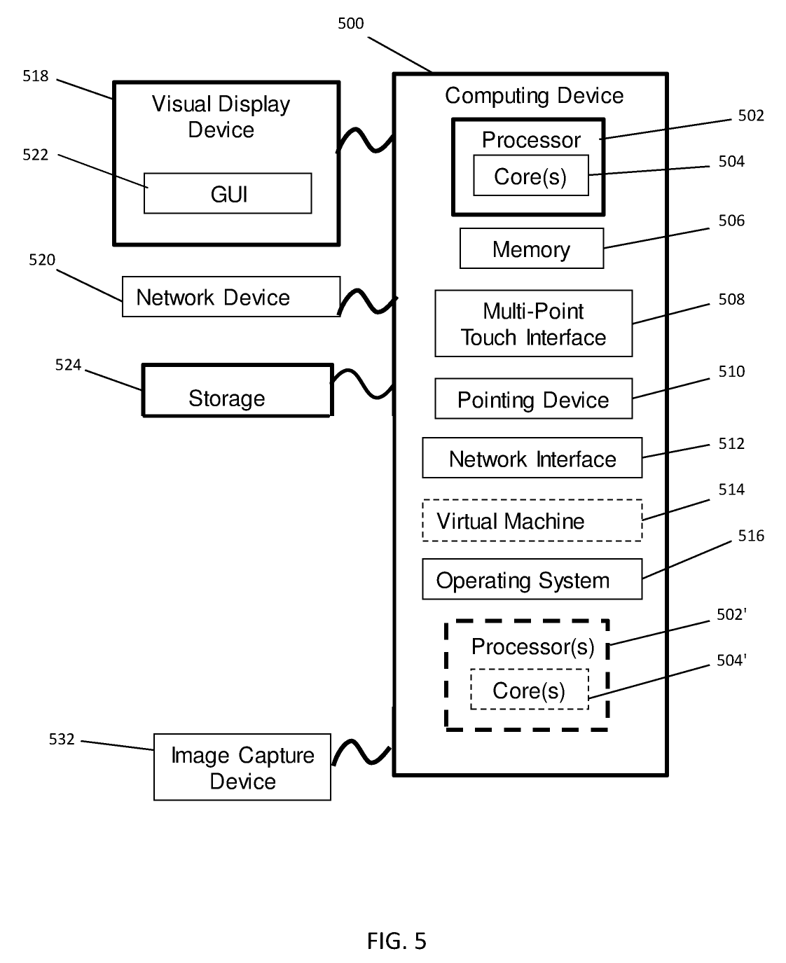

FIG. 5 is a block diagram of an exemplary computing device 500 that can be used to perform one or more steps of the methods provided by exemplary embodiments. For example, computing device 500 may be the courier video recording system, customer video recording system, or a blockchain node. The computing device 500 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 506 included in the computing device 500 can store computer-readable and computer-executable instructions or software for implementing exemplary embodiments. The computing device 500 also includes processor 502 and associated core 504, and optionally, one or more additional processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ can each be a single core processor or multiple core (504 and 504′) processor. An image capture device 532 is in communication with the computing device 500.

Virtualization can be employed in the computing device 500 so that infrastructure and resources in the computing device can be shared dynamically. A virtual machine 514 can be provided to handle a process running on multiple processors so that the process appears to be using only one computing resource rather than multiple computing resources. Multiple virtual machines can also be used with one processor.

Memory 506 can include a computer system memory or random access memory, such as DRAM, SRAM, EDO RAM, and the like. Memory 506 can include other types of memory as well, or combinations thereof. An individual can interact with the computing device 500 through a visual display device 518, such as a touch screen display or computer monitor, which can display one or more user interfaces 522 for receiving data from the individual. The visual display device 518 can also display other aspects, elements and/or information or data associated with exemplary embodiments. The computing device 500 can include other I/O devices for receiving input from a individual, for example, a keyboard or another suitable multi-point touch interface 508, a pointing device 510 (e.g., a pen, stylus, mouse, or trackpad). The keyboard 508 and the pointing device 510 can be coupled to the visual display device 518. The computing device 500 can include other suitable conventional I/O peripherals.

The computing device 500 can also include one or more storage devices 524, such as a hard-drive, CD-ROM, or other computer readable media, for storing data and computer-readable instructions and/or software that implements exemplary embodiments of the system as described herein, or portions thereof, which can be executed to generate user interface 522 on display 518. Exemplary storage device 524 can also store one or more databases for storing suitable information required to implement exemplary embodiments. The databases can be updated by an individual or automatically at a suitable time to add, delete or update one or more items in the databases. Exemplary storage device 524 can store one or more databases for storing provisioned data, and other data/information used to implement exemplary embodiments of the systems and methods described herein.

The computing device 500 can include a network interface 512 configured to interface via one or more network devices 500 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 512 can include a built-in network adapter, network interface card, PCMCIA network card, card bus network adapter, wireless network adapter, USB network adapter, modem or another device suitable for interfacing the computing device 500 to a type of network capable of communication and performing the operations described herein. Moreover, the computing device 500 can be a computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 500 can run an operating system 516, such as versions of the Microsoft® Windows® operating systems, the different releases of the Unix and Linux operating systems, a version of the MacOS® for Macintosh computers, an embedded operating system, a real-time operating system, an open source operating system, a proprietary operating system, an operating systems for mobile computing devices, or another operating system capable of running on the computing device and performing the operations described herein. In exemplary embodiments, the operating system 516 can be run in native mode or emulated mode. In an exemplary embodiment, the operating system 516 can be run on one or more cloud machine instances.

The description is presented to enable a person skilled in the art to create and use a computer system configuration and related method and systems for dynamic delivery scheduling. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts have been provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be provided separately or in any suitable sub-combination. Accordingly, it is submitted that the scope of protection sought herein should not be limited to the described embodiments but rather should be limited only by the spirit and scope of the following claims.

What is claimed is:

1. A method for delivery verification, the method comprising:
initiating, by a courier, delivery of a package by submitting an action to a distributed ledger;
recording, by a courier video capture system, video of the delivery of the package by the courier to a customer site;
completing delivery of the package by the courier to the customer site by sending a code to a distributed ledger;
sending the video of the delivery of the package captured by the courier video capture system to a blockchain referenced by the distributed ledger;
compiling, by the distributed ledger, the video of the delivery of the package captured by the courier video capture system and adding the video of the delivery of the package captured by the courier video capture system to the blockchain;
capturing, by a customer video capture system, any motion detected video of the package occurring for at least one of delivery of the package or after delivery of the package by the courier;
requesting, by the distributed ledger, the motion-detected video of the package captured by the customer video capture system; and
adding the motion detected video footage captured after delivery of the package by the customer video capture system to the blockchain.

2. The method of claim 1 further comprising:
initiating action for a customer device to capture video regarding the delivery of the package;
recording, by the customer video capture system, delivery of the package to the customer;
sending video of the delivery of the package captured by the customer video capture system to the blockchain referenced by the distributed ledger; and
compiling, by the distributed ledger, the video of the delivery of the package captured by the customer video capture system and adding the video of the delivery of the package captured by the customer video capture system to the blockchain.

3. The method of claim 1 wherein when the customer location is dynamic, requesting, by the distributed ledger, geographic metadata to be collected and distributed from the video capture system.

4. The method of claim 3 further comprising distributing, by the video capture device, geographic metadata to the distributed ledger.

5. The method of claim 2 further comprising determining, by the distributed ledger, a preferred video recording system to be used to capture the delivery to the customer.

6. The method of claim 1 further comprising sending, by the distributed ledger, the block chain reference to the courier for video distribution.

7. The method of claim 1 further comprising requesting, by the courier, a handshake with the customer's network.

8. The method of claim 7 further comprising receiving, by the courier, a code from the customer's network.

9. The method of claim 8 further comprising accepting, by the courier, the code.

10. A delivery verification system comprising:
one or more computer-readable media storing instructions for delivery verification:
one or more devices operatively coupled to the computer-readable media, the one or more devices being configured to:
initiate, by a courier, delivery of a package by submitting an action to a distributed ledger;
record, by a courier video capture system, video of the delivery of the package to the customer site;
complete delivery of the package by the courier to the customer site by sending a code to the distributed ledger;
send video of the delivery of the package captured by the courier video capture system to a blockchain referenced by the distributed ledger;
compile, by the distributed ledger, the video of the delivery of the package by the courier video capture system and adding the video of the delivery of the package by the courier video capture system to the blockchain;
capture, by a customer video capture system, any motion detected video of the package occurring after delivery of the package by the courier;
request, by the distributed ledger, any motion detected video of the package captured by the customer video capture system;
receive, by the customer, the package and send a message to the distributed ledger that the package has been received; and
add the motion detected video of the package captured by the customer video capture system.

11. The system of claim 10 further comprising wherein the one or more devices are further configured to:
initiate action for a customer device to capture video regarding the delivery of the package;
record, by the customer video capture system, delivery of the package to the customer;
send video of the delivery of the package captured by the customer video capture system to the blockchain referenced by the distributed ledger; and
compile, by the distributed ledger, the video of the delivery of the package captured by the customer video capture system and adding the video of the delivery of the package captured by the customer video capture system to the blockchain.

12. The system of claim 10 wherein when the customer location is dynamic, request, by the distributed ledger, geographic metadata to be collected and distributed from the video capture system.

13. The system of claim 10 wherein the one or more devices are further configured to distribute, by the video capture device, geographic metadata to the distributed ledger; and determine, by the distributed ledger, a preferred video recording system to be used to capture the delivery to the customer.

14. The system of claim 10 wherein the one or more devices are further configured to send, by the distributed ledger, the block chain reference to the courier for video distribution.

15. The system of claim 10 wherein the one or more devices are further configured to:
request, by the courier, a handshake with the customer's network;
receive, by the courier, a code from the customers network; and
accept, by the courier, the code.

16. A non-transitory computer-readable medium storing instructions that when executed by a processing device cause the processing device to:
initiate, by a courier, delivery of a package by submitting an action to a distributed ledger;
record, by a courier video capture system, video of the delivery of the package to the customer site;
complete delivery of the package by the courier to the customer site by sending a code to the distributed ledger;
send video of the delivery of the package captured by the courier video capture system to a blockchain referenced by the distributed ledger;
compile, by the distributed ledger, the video of the delivery of the package by the courier video capture system and adding the video of the delivery of the package by the courier video capture system to the blockchain;
capture, by a customer video capture system, any motion detected video of the package occurring after delivery of the package by the courier;
request, by the distributed ledger, any motion detected video of the package captured by the customer video capture system;
receive, by the customer, the package and send a message to the distributed ledger that the package has been received; and
add the motion detected video of the package captured by the customer video capture system.

17. The delivery verification system of claim 16 wherein the instructions cause the processing device to:
initiate action for a customer device to capture video regarding the delivery of the package;
record, by the customer video capture system, delivery of the package to the customer;
send video of the delivery of the package captured by the customer video capture system to the blockchain referenced by the distributed ledger; and
compile, by the distributed ledger, the video of the delivery of the package captured by the customer video capture system and adding the video of the delivery of the package captured by the customer video capture system to the blockchain.

18. The delivery verification system of claim 16 wherein the instructions cause the processing device to determine when the customer location is dynamic, and request, by the distributed ledger, geographic metadata to be collected and distributed from the video capture system.

19. The delivery verification system of claim 17 wherein the instructions cause the processing device to distribute, by the video capture device, geographic metadata to the distributed ledger; and determine, by the distributed ledger, a preferred video recording system to be used to capture the delivery to the customer.

20. The delivery verification system of claim 17 wherein the instructions cause the processing device to:
request, by the courier, a handshake with the customer's network;
receive, by the courier, a code from the customers network; and
accept, by the courier, the code.
